(19) United States
(12) Patent Application Publication
(10) Pub. No.: US 2006/0240160 A1
(43) Pub. Date: Oct. 26, 2006

(54) Mixing and kneading arrangement

(75) Inventors: Ulrich Peitzmeier, Verl (DE); Meinolf Baak, Rietberg (DE)

Correspondence Address: BROWDY AND NEIMARK, P.L.L.C.;624 NINTH STREET, NW, SUITE 300, WASHINGTON, DC, 20001-5303, US

(73) Assignee: Neuenkirchener Mashinenfabrik Emil Kemper GmbH, Reithberg (DE)

(21) Appl. No.: 11/409,036

(22) Filed: Apr. 24, 2006

(30) Foreign Application Priority Data
Apr. 23, 2005 (DE) 10 2005 019 082.0

(51) Int. Cl. A21D 6/00

(52) U.S. Cl. 426/504

(57) ABSTRACT

A mixing and kneading arrangement has a kneading vat and at least one kneading tool. A spray device in the arrangement has at least one spray nozzle in order to produce a spray mist in the kneading vat. Furthermore, the spray device has a feeding device for feeding liquid or liquefied dough components into the spray nozzle. The spray device furthermore has a source for gas which contains oxygen and a pressure unit, which sets the gas which contains oxygen under pressure. In a spray head in the spray nozzle, the liquid or liquefied dough components are combined with the gas which contains oxygen and which is under pressure to produce the spray mist.

### FIELD OF THE INVENTION

The invention relates to a mixing and kneading arrangement with a kneading vat, at least one kneading tool, and a spray device comprising at least one spray nozzle for the production of spray mist in the kneading vat and comprising a feeding device for feeding liquid or liquefied dough components into the spray nozzle.

### BACKGROUND OF THE INVENTION

An arrangement of this nature is already known from DE 200 05 553 U1. With regard to the formation and the development of dough, the arrangement described therein still requires improvement.

### SUMMARY OF THE INVENTION

The object of the present invention is therefore to further develop a mixing and kneading arrangement of the type mentioned in the introduction in such a manner that the formation and the development of the dough in the mixing and kneading arrangement is improved.

This object is attained according to the invention by means of a mixing and kneading arrangement having a spray device comprising a source for a gas which contains oxygen and a pressure unit which sets the gas containing oxygen under pressure, wherein the spray nozzle comprises a spray head, in which the liquid or liquefied dough components are combined with the gas which contains oxygen and which is under pressure in order to produce the spray mist.

According to the invention, it has first been recognised that for the form ation and development of the dough in the mixing and kneading arrangement, it is of key importance to provide a controlled oxidation ratio during the mixing and kneading procedure. In the known mixing and kneading arrangements, this is essentially left to chance. The spray facility according to the invention makes it possible to produce a spray mist with a controllable oxygen content. Here, the oxygen content can be adjusted by selecting the gas which contains oxygen or the pressure with which the gas is fed to the spray head. A mixing and kneading arrangement results in which sufficient moisture is created in the dough components contained in the kneading vat. The oxidative process during the feeding of the liquid or liquefied dough components, which can be well controlled via the oxygen content, ensures improved dough formation. The mechanised energy which is applied via at least one kneading tool results in an improvement in the development of the dough.

A spray device comprising several gas sources with assigned pressure units and at least one mixing unit for mixing the gases in a controlled manner increases flexibility when presetting a spray mist which is adapted to the individual mixing and kneading conditions. With the help of gas sources, gases with different oxygen quantities and, if necessary, with different quantities of other reactive components, can be provided.

A spray device comprising at least one dosing unit for the dosed addition of at least one of the group of the liquid and liquefied dough components and at least one gas also makes it possible to control the composition of the spray mist by dosing individual components which are fed into the spray nozzle.

A spray device comprising a dosing unit assigned to each gas source is further improved with regard to the setting options. The oxygen content can also be preset by dosing the individual gases which are fed in.

A gas which contains oxygen, the gas being at least one of the group of the following gases: oxygen, air, nitrogen/oxygen mixture, has been shown to be particularly advantageous in tests in terms of achieving good baking results.

A tempering unit for presetting the temperature of at least one of the group of the liquid and liquefied dough components and at least one gas before leaving the spray head creates a further setting option for the spray mist which is produced. Via the specified temperature of the components which are fed in via the spray nozzles, the temperature of the dough can also be influenced, which also enables an improvement to be made to the mixing and kneading result.

An oxygen measuring sensor for presetting the oxygen content of at least one gas containing oxygen before leaving the spray head optimises the opportunities for setting the oxygen content of the spray mist.

The invention will now be described in greater detail below by way of an exemplary embodiment which is explained with reference to the drawing.

### BRIEF DESCRIPTION OF THE DRAWING

FIG. 1 shows a diagram of a partial cross-section through a mixing and kneading arrangement with a spray facility, and

FIG. 2 shows a top view of the mixing and kneading arrangement, wherein the components of the spray facility have been left out, with the exception of a spray mist which is produced from spray openings.

### DESCRIPTION OF THE PREFERRED EMBODIMENT

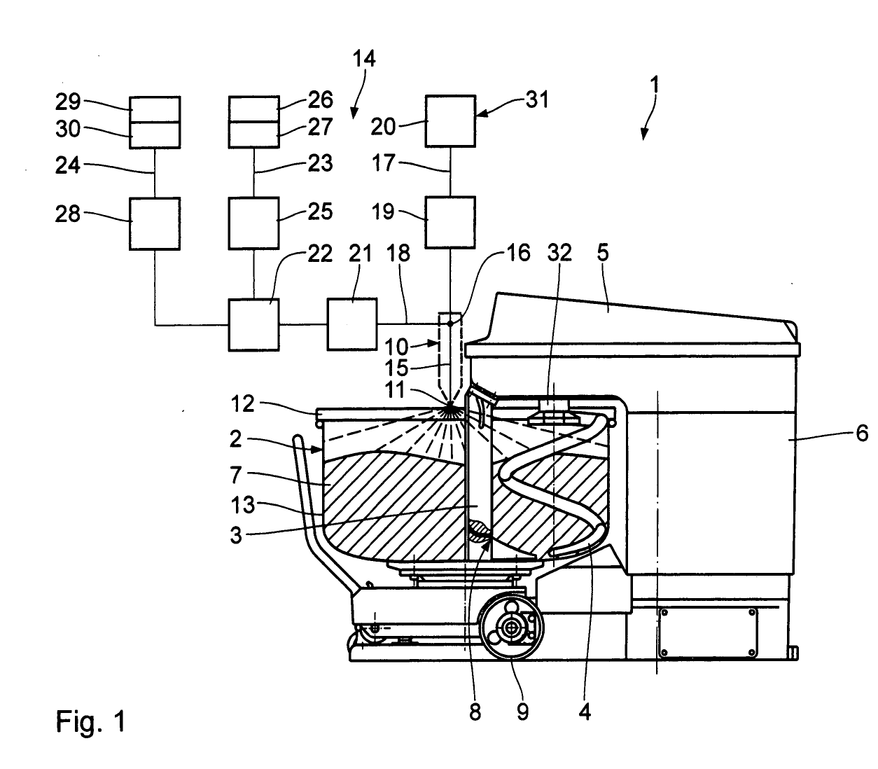

A mixing and kneading arrangement for dough, labelled overall as 1 in FIG. 1, has a kneading vat 2, in which a kneading and guide rod 3 and a kneading spiral 4 are arranged as kneading tools. The kneading tools 3, 4 are connected with a head piece 5 of a control and drive unit 6 of the mixing and kneading arrangement 1. The control and drive unit 6 can be used to move the head piece 5 upwards until the kneading tools 3 and 4 which are connected with the head piece 5 have moved out of the kneading vat 2.

The temperature of the dough or dough components 7 can be measured by a temperature sensor 8 of type PT100, which is arranged in a bare section of the kneading and guide rod 3. Using a tempering facility which is not shown in greater detail and using the measured values of the temperature sensor 8, and regulated on the basis of this data by a central computing unit in the control and drive unit 6, the temperature of the dough 7 in the kneading vat 2 can be automatically adapted to a prespecified value.

The kneading vat 2 is pivoted around its vertical symmetry axis. In order to rotate the kneading vat 2 during the kneading procedure, the mixing and kneading arrangement 1 comprises a drive motor 9.

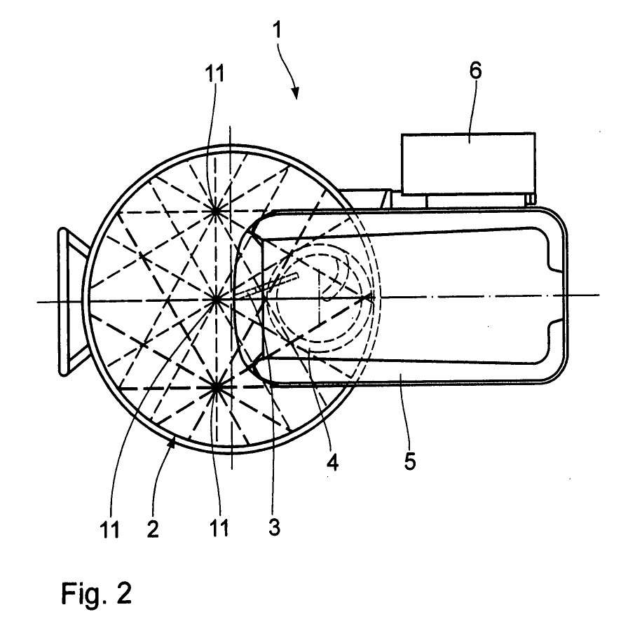

In order to produce a spray mist in the kneading vat 2, a plurality of spray nozzles 10 are used, of which a spray nozzle 10 with a spray head represented by a broken line is shown in FIG. 1. The position of the spray openings 11 on the vat side of the total of three spray nozzles 10 in the embodiment shown is shown in FIG. 2. In the area of the spray openings 11, the spray nozzles 10 are mounted onto a cover 12 of the kneading vat 2. The cover 12, which does not rotate when the kneading vat 2 is rotated, seals the upper part of the kneading vat 2, so that neither dough 7 nor dough components can escape. The spray openings 11 therefore all lie above the volume which is restricted by the kneading vat 2. One of the spray openings 11 lies approximately on the rotating axis of the kneading vat 2. The two other spray openings 11 lie mirror inverted in FIG. 2 above and below the central spray opening 11 which lies on the rotating axis. This distance between these two additional spray openings 11 to a casing wall 13 of the kneading vat 2 is approximately the same as the distance between these two spray openings 11 and the central spray opening 11.

One of the total of three spray devices 14 which belong in each case to the spray nozzles 10, is described below with reference to the spray device 14 shown in FIG. 1. The spray opening 11 represents the end of a mixing line 15 which runs in the spray nozzle 10. On the end section of the spray nozzle 10 which lies opposite the spray opening 11, an intersection 16 is arranged, in which a component feeding line 17 is connected with a gas mixing line 18.

The component feeding line 17 is used to feed in liquid or liquefied dough components to the spray nozzle 10. Upstream of the intersection 16 in the component feeding line 17, a tempering unit 19 is arranged in order to prespecify the temperature of the liquid or liquefied dough components. Upstream of the tempering unit 19, a reservoir 20 for the liquid or liquefied dough components is arranged. The liquid or liquefied dough components can be water, salt, yeast and, if necessary, oxidation components, for example.

Upstream of the intersection 16, in the gas mixing line 18, a tempering unit 21 is arranged in order to prespecify the temperature of the gas conveyed in the gas mixing line 18 before leaving the spray nozzle 10. Upstream of the tempering unit 21, in the gas mixing line 18, a mixing unit 22 is arranged. Here, a first gas feeding line 23 and a second gas feeding line 24 join to form the gas mixing line 18.

Upstream of the mixing unit 22, in the first gas feeding line 23, a first dosing unit 25 is arranged. Upstream of the first dosing unit 25, a first gas source 26 with an assigned first pressure unit 27 is arranged. Upstream of the mixing unit 22, in the second gas feeding line 24, a second dosing unit 28 is arranged. Upstream of the second dosing unit 28, a second gas source 29 with an assigned second pressure unit 30 is arranged.

The gases supplied from the gas sources 26, 29 contain oxygen. These gases can be pure oxygen, air, or a mixture of nitrogen and oxygen.

The component feeding line 17 forms together with the tempering unit 19 and the reservoir 20 an feeding device 31 for feeding the liquid or liquefied dough components into the spray nozzle 10. For the different spray nozzles 10, it is not necessary in each case to provide separate gas sources 26, 29 or a separate feeding device 31. Rather, it is possible that, depending on the arrangement of the flexibility when adjusting the spray mist in the individual spray nozzles 10, a branching occurs in the feeding lines 17, 23, 24 or the mixing line 18 which runs through to the intersections 16 of the different spray nozzles 10. Both the spray devices 14 and the feeding device 31 are connected via signals with the central computing unit of the control and drive unit 6, so that control or regulation of the individual components in the devices 14, 31 is possible.

The mixing and kneading arrangement 1 functions as follows: alongside the liquid or liquefied dough components, flour and, if necessary, additional non-liquid and non-liquefied components, are added to the kneading vat 2, in order to produce the dough 7. The addition of non-liquid and non-liquefied components is made using a feeding pipe 32 above the kneading spiral 4. The addition of the liquid or liquefied dough components is made here via the spray nozzles 10. In these nozzles, a mixture of the gases which contain oxygen which come from the gas sources 26, 29, which is under pressure, is fed into the liquid or liquefied dough components. The spray mist which is produced as a result in the kneading vat 2 can therefore be well controlled with regard to its oxygen content. This control of the oxygen content is achieved via the mixing ratio of the gases from the gas sources 26, 29, which can be set via the dosing units 25, 28 and the mixing unit 22. The mixing ratio can in addition be achieved via the individual tempering of the gases from the gas sources 26, 29 via further tempering units arranged in the feeding lines 23, 24 and which are not shown. Due to the resulting controllable feeding of oxygen via the spray mist, sufficient moisturisation, in particular of the singular particles in the non-liquid dough components, in particular of the flour, is achieved. During the kneading process, an adequately aerobic situation is thus created in the dough 7. Due to the fact that its oxidative process can be influenced as a result of the controllable oxygen content, the formation of the dough 7 is improved. For example, the redox pair oxygen and L-ascorbic acid, the most important flour treatment agent, can be made to react directly in the mixing and kneading arrangement 1, thus improving and accelerating the dough development. These oxidative processes improve or accelerate the dough development in the kneading vat 2 within the kneading zone in which the kneading tools 3, 4 influence the dough, and within the remaining resting area of the kneading vat 2. Here, the proteins contained in the dough in particular oxidise, which promotes the required agglutination of the dough.

The arrangement of the spray nozzles 10 in the cover 12 guarantees an evenly distributed moisturisation of the dough or the dough components 7. Due to the pressure units 27, 30 and via the corresponding adjustment options in the spray nozzles 10, the form and degree of spraying via the spray mist can be variably adjusted. The temperature of the spray mist can also be adjusted via the tempering units 19, 21. Via the tempering units 19, 21, a fine adjustment of the oxygen content of the spray mist is also possible. With a variant of the mixing and kneading arrangement 1, the oxygen content can be regulated on the basis of the measured values from an oxygen measuring sensor which is not shown, which can be arranged, for example, in the gas mixing line 18 adjacent to the tempering unit 21. The oxygen sensor is connected via signals with the central computing unit of the control and drive unit 6, so that an automatic adaptation of the oxygen content of the spray medium to a prespecified value is possible. The adaptation options described for the mixing and kneading arrangement 1 guarantee the production of different doughs 7. Here in particular, an adaptation to the individual dough composition can be achieved. The dough which is thus produced and processed using the mixing and kneading arrangement 1 can then be further processed to create smaller dough pieces. In particular, prefermented and frozen smaller dough pieces can be produced from the dough produced using the mixing and kneading arrangement 1 without a reduction in quality.

In addition, any formation of flour dust which may occur during the mixing phase is suppressed by the spray mist.

Overall, the quality of the dough 7 produced and processed using the mixing and kneading arrangement 1 is controlled depending on the oxygen content, the rotational speed of the kneading spiral 4 and the temperature of the dough 7 which is regulated using the temperature sensor 8.

What is claimed is:

1. A mixing and kneading arrangement (1)
with a kneading vat (2),
with at least one kneading tool (3, 4),
with a spray device (14),
with at least one spray nozzle (10) for the production of spray mist in the kneading vat (2) and
with a feeding device (31) for feeding liquid or liquefied dough components into the spray nozzle (10),
wherein that spray device (14) comprises:
a source (26, 29) for a gas which contains oxygen,
a pressure unit (27, 30), which sets the gas containing oxygen under pressure,
wherein the spray nozzle (10) comprises a spray head, in which the liquid or liquefied dough components are combined with the gas which contains oxygen and which is under pressure in order to produce the spray mist.

2. A mixing and kneading arrangement according to claim 1, wherein the spray device (14) comprises:
several gas sources (26, 29) with assigned pressure units (27, 30),
at least one mixing unit (22) for mixing the gases in a controlled manner.

3. A mixing and kneading arrangement according to claim 1, wherein the spray device (14) comprises at least one dosing unit (25, 28) for the dosed addition of at least one of the group of the liquid and liquefied dough components and at least one gas.

4. A mixing and kneading arrangement according to claim 3, wherein a dosing unit (25, 28) is assigned to each gas source (26, 29).

5. A mixing and kneading arrangement according to claim 1, wherein at least one of the group of the following gases is used as a gas containing oxygen: oxygen, air, nitrogen/oxygen mixture.

6. A mixing and kneading arrangement according to claim 1, having a tempering unit (19, 21) for presetting the temperature of at least one of the group of the liquid and liquefied dough components and at least one gas before leaving the spray head (10).

7. A mixing and kneading arrangement according to claim 1, having an oxygen measuring sensor for presetting the oxygen content of at least one gas containing oxygen before leaving the spray head (10).
